(19) United States
(12) Patent Application Publication
(10) Pub. No.: US 2022/0156848 A1
(43) Pub. Date: May 19, 2022

(54) System for Reducing Tax Credit Risk

(71) Applicant: Thomas A. Zavieh, Roswell, GA (US)

(72) Inventor: Thomas A. Zavieh, Roswell, GA (US)

(21) Appl. No.: 17/506,106

(22) Filed: Oct. 20, 2021

Related U.S. Application Data
(60) Provisional application No. 63/114,917, filed on Nov. 17, 2020.

(51) Int. Cl. G06Q 40/00

(52) U.S. Cl. CPC G06Q 40/123

(57) ABSTRACT

In a method of reducing risk associated with a taxpayer claiming a tax credit issued by a taxing authority, qualifying activities are analyzed and an output indicating a range of amounts that taxpayer is eligible to claim is generated. The taxpayer is prequalified for a tax credit policy based on the range of amounts. A report that includes the amount of the tax credit is generated and is transmitted to an insurance company. When the report meets a set of standards for the insurance company, then an insurance agreement is entered into between the insurance company and the taxpayer, which obligates the insurance company to pay for an audit defense for the taxpayer if the taxpayer is audited and obligates the insurance company to pay the taxpayer a difference between the claimed amount of the tax credit and an amount of the tax credit that is allowed.

### CROSS-REFERENCE TO RELATED APPLICATION(S)

This application claims the benefit of US Provisional Patent Application Ser. No. 63/114,917, filed Nov. 17, 2020, the entirety of which is hereby incorporated herein by reference.

### BACKGROUND OF THE INVENTION

### 1. Field of the Invention

The present invention relates to a risk reducing system and, more specifically, to a system for reducing risk associated with research and development tax credits.

### 2. Description of the Related Art

Many governments provide private industry with incentives to engage in research and development (R&D). In the United States, the Research and Experimentation (R&E) tax credit (also referred to as “the R&D tax credit”), was introduced to encourage U.S. companies to invest in R&D during any given tax year by providing businesses that develop new, improved, or technologically advanced products or trade processes with a credit that offset tax liability, improves cash flow and in some cases increase earnings per share. The credit is also available to businesses that have made improvements in the performance, functionality, reliability, or quality of existing products or processes.

The R&D tax credit is set forth in Section 41 of the Internal Revenue Code (IRC) and further defined in the related regulations. It applies to any taxpayer that incurs expenses in association with the performance of Qualified Research Activities (QRA) on U.S. soil.

The following types of Qualified Research Expenses (QRE) can be used in calculating the R&D credit:
Wages paid to employees for qualified services (including amounts considered to be wages for federal income tax withholding purposes);
Supplies (defined as any tangible property other than land or improvements to land, and property subject to depreciation) used and consumed in the R&D process;
Contract research expenses paid to a third party for performing QRAs on behalf of the taxpayer, regardless of the success of the research, allowed at 65% of the actual cost incurred; and
Basic research payments made to qualified educational institutions and various scientific research organizations, allowed at 75% of the actual cost incurred.

To qualify as research according to IRC section 41, the taxpayer must show that the activities:
are intended to resolve technological uncertainty that exists at the outset of the project or initiative, related to the capability or methodology for developing or improving the business component or the appropriate design of the business component;
rely on a hard science, such as engineering, computer science, biological science, or physical science;
relate to the development of a new or improved business component, defined as new or improved products, processes, internal use computer software, techniques, formulas, or inventions to be sold or used in the taxpayer's trade or business; and
substantially all constitute a process of experimentation involving testing and evaluation of alternatives to eliminate technological uncertainty.

Unfortunately, the risk associated with claiming the R&D tax credit is an audit performed by the U.S. Internal Revenue Service (IRS) and if a separate State credit was claimed, by that States revenue agency. When the IRS (and/or State revenue agency) audits R&D tax credits, often the taxpayer engages in negotiations with the IRS (and/or State revenue agency) revenue agents and can lead to litigation at tax court and appeals. Such negotiations frequently result in the allowance of a percentage of the originally-claimed credit. Also, there is a risk of complete disallowance of a claim and even of a penalty being levied against a taxpayer making such a claim. As a result, many taxpayers tend to under-claim the R&D tax credits to which they are entitled.

Therefore, there is a need for a system that reduces the risk associated with the taking of R&D tax credits.

### SUMMARY OF THE INVENTION

The disadvantages of the prior art are overcome by the present invention which, in one aspect, is a system that eliminates the risk to the taxpayer associated with taking an R&D tax credit. Under the system, the taxpayer's qualifying R&D tax credit-associated activities are assessed and evaluated by an insurance underwriter. If the metrics of such activities are found acceptable, an insurance company will issue an R&D tax credit insurance policy and then the taxpayer will claim the credit. If the credit is not allowed by the taxing authority, then the insurance policy will pay for any audit defense and litigation activities to a pre-agreed upon level (e.g., through an administrative appeal). If the taxpayer's representatives ultimately settle for a credit at an amount below the originally-claimed credit, then the insurance policy will pay the difference between the claimed amount and the settled amount minus a pre-agreed deductible amount or percentage.

In another aspect, the invention is a method of reducing risk associated with a taxpayer claiming a tax credit issued by a taxing authority. Qualifying activities by the taxpayer relating to the tax credit are analyzed and an output indicating a range of amounts that taxpayer is eligible to claim for the tax credit is generated. The taxpayer is prequalified for a tax credit policy based on the range of amounts. A report that includes a computation of the amount of the tax credit is generated. The report is transmitted to an insurance company. When the report meets a set of standards for the insurance company, then an insurance agreement is entered into between the insurance company and the taxpayer. The insurance agreement includes a provision that obligates the insurance company to pay for an audit defense for the taxpayer if the taxpayer is audited and that obligates the insurance company to pay the taxpayer a difference between the claimed amount of the tax credit and an amount of the tax credit that is allowed.

In yet another aspect, the invention is a computerized system for reducing a risk associated with a taxpayer claiming a tax credit, which includes a tax advising entity computational device in communication with a computer network. The tax advising entity computational device is programmed to: analyze qualifying activities by the taxpayer relating to the tax credit and to generate an output indicating a range of amounts that taxpayer is eligible to claim the tax credit; pre-qualify the taxpayer for a tax credit policy based on the range of amounts; generate a report that includes a computation of the amount of the tax credit; and transmit the report to an insurance entity. An insurance entity computational device in communication with the computer network is programmed to determine when the report meets a set of standards for the insurance company, then enter into an insurance agreement between the insurance company and the taxpayer. The insurance agreement includes a provision that obligates the insurance company to pay for an audit defense for the taxpayer if the taxpayer is audited and that obligates the insurance company to pay the taxpayer a difference between the claimed amount of the tax credit and an amount of the tax credit that is allowed.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a flow chart that demonstrates one embodiment of a system for reducing risk associated with taking a tax credit.

FIG. 2 is a schematic diagram of one embodiment of the system.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

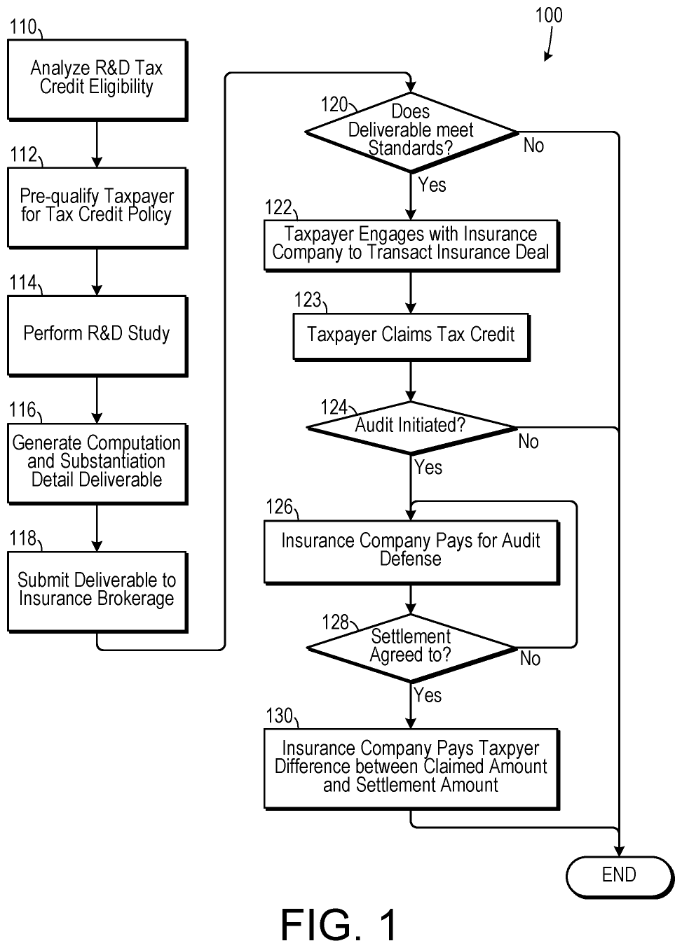

As shown in FIG. 1, in one representative embodiment of a system 100 for reducing risk associated with taking a tax credit, such as a research and development tax credit, an tax advising entity (such as a tax accountant or a tax attorney) will analyze the facts presented by the taxpayer to determine eligibility for the tax credit 110 using the test provided by the taxing authority (for example, the US IRS or other authority in other jurisdictions). The US IRS employs a four-part text for R&D tax credit eligibility, which in the United States is embodied in 26 USC § 41. A similar deduction is embodied in 26 USC § 174. At the end of this step, the tax advising entity will generate an estimate of the range of the credit for which the taxpayer qualifies.

The tax advising entity can also perform a pre-qualification work-up of the taxpayer's situation 112 and submit the results to an insurance company to seek a pre-qualification (this step may be optional). Pre-qualification can provide the tax advising entity and the taxpayer with a heightened comfort level regarding the cost of executing the subsequent steps.

The tax advising entity will then conduct a detailed study 114 to determine the amount of tax credit that should be claimed. This study includes two components: (1) a quantitative component; and (2) a qualitative component. The quantitative component examines the taxpayer's expenditures (e.g., employee time and wages; costs of supplies; contractor costs; and other costs) that are directly related to the criteria for the credit set forth by the taxing authority for the credit (e.g., the IRS's four-part test). The qualitative component examines such things as the documentation provided by the taxpayer for its evidentiary value. (Such documentation can include such things as purchase orders, invoices, documentation related to software development and W-2s.) The tax advising entity will generate a report that demonstrates the applicability of the taxpayer's situation to the criteria set forth by the taxing authority. The report will also include an appendix that includes the applicable documentation and evidence.

The tax advising entity will then generate a computation of the tax credit 116 and substantiate the computation from the report. An executive summary of the analysis will be generated that shows the results of the computation along with a summary of the report. This results in a deliverable, a limited version of which is submitted to an insurance brokerage 118. (Certain parts of the deliverable may not be included in the package sent to the brokerage so as to comply with non-disclosure agreements and secrecy orders, etc.) Then insurance brokerage 118 may submit the limited version deliverable to several insurance companies to seek the best rates and conditions.

If the deliverable meets the standards of one or more insurance companies 120, the taxpayer will engage with a selected one of the insurance companies to transact an insurance deal 122. This will result in the issuance of an R&D tax credit insurance policy to the taxpayer.

Once the insurance policy has been issued, the taxpayer will submit a tax return claiming the tax credit 123. If the taxing authority initiates an audit 124 of the taxpayer with respect to the claimed credit, the insurance company will pay for the audit defense up to the amount agreed to in the insurance policy 126. For example, the policy may limit the insurance company's liability to the end of an administrative appeal. However, the policy could include provisions that would bind the insurance company to pay for appeals in a tax court, depending on the exact agreement between the insurance company and the taxpayer. The coverage could include payment for accountant and attorney time, as well as expert expenses and other costs, depending upon the agreement between the taxpayer and the insurance company.

If a settlement agreement is reached between the taxpayer and the taxing authority 128, such as a settlement in which a percentage of the claimed credit is allowed (or a specific dollar amount), then the insurance company will pay the taxpayer the difference between the claimed amount and the settlement amount 130, subject to any pre-agreed deductibles. For example, if the taxpayer claimed a credit in the amount of $1,000,000.00, was audited and agreed to settle for 90% of the credit, and if the policy included a $10,000.00 deductible, then the insurance company would pay the taxpayer $90,000.00.

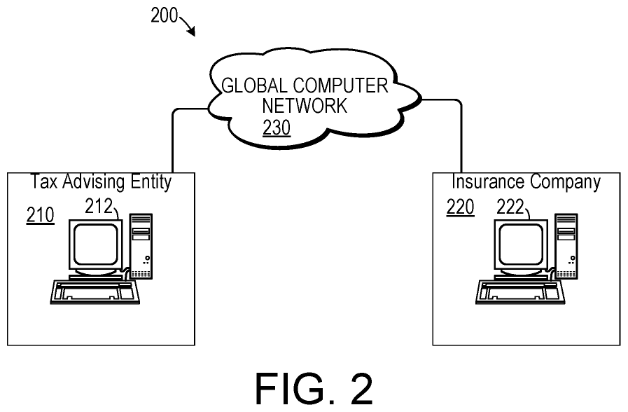

The process of the system 200 is shown graphically in FIG. 2. The system offers the advantage of reducing the risk associated with tax credit decision making. It includes at least a computational device 212 operated by a tax advising entity 210 (such as an accountant or tax attorney) that is in communication via a computer network 230 with a computational device 222 operated by an insurance company 220. Additional computers may be employed, for example, by the taxpayer and by an insurance brokerage.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of reducing risk associated with a taxpayer claiming a tax credit issued by a taxing authority, comprising the steps of:
(a) analyzing qualifying activities by the taxpayer relating to the tax credit and generating an output indicating a range of amounts that taxpayer is eligible to claim for the tax credit;
(b) pre-qualifying the taxpayer for a tax credit policy based on the range of amounts;
(c) generating a report that includes a computation of the amount of the tax credit;
(d) transmitting the report to an insurance company;
(e) when the report meets a set of standards for the insurance company, then entering into an insurance agreement between the insurance company and the taxpayer, wherein the insurance agreement includes a provision that obligates the insurance company to pay for an audit defense for the taxpayer if the taxpayer is audited and that obligates the insurance company to pay the taxpayer a difference between the claimed amount of the tax credit and an amount of the tax credit that is allowed.

2. The method of claim 1, wherein the pre-qualifying step includes examining a quantitative component that examines expenditures by the taxpayer that are directly related to criteria for the credit set forth by the taxing authority for the credit.

3. The method of claim 2, wherein the quantitative component includes items selected from a list consisting of: employee time and wages; costs of supplies; and contractor costs.

4. The method of claim 1, wherein the pre-qualifying step includes examining a qualitative component that examines documentation provided by the taxpayer for its evidentiary value.

5. The method of claim 4, wherein the documentation is selected from a list consisting of: purchase orders, invoices, documentation related to software development and W-2s.

6. The method of claim 1, wherein the report demonstrates applicability of the taxpayer's situation to criteria set forth by the taxing authority and includes an executive summary that shows the results of the computation along with a summary of the report.

7. A computerized system for reducing a risk associated with a taxpayer claiming a tax credit, comprising:
(a) a tax advising entity computational device in communication with a computer network and programmed to:
(i) analyze qualifying activities by the taxpayer relating to the tax credit and to generate an output indicating a range of amounts that taxpayer is eligible to claim the tax credit;
(ii) pre-qualify the taxpayer for a tax credit policy based on the range of amounts;
(iii) generate a report that includes a computation of the amount of the tax credit; and
(iv) transmit the report to an insurance entity; and
(b) an insurance entity computational device in communication with the computer network and programmed to determine when the report meets a set of standards for the insurance company and, if the report meets the set of standards, then enter into an insurance agreement between the insurance company and the taxpayer, wherein the insurance agreement includes a provision that obligates the insurance company to pay for an audit defense for the taxpayer if the taxpayer is audited and that obligates the insurance company to pay the taxpayer a difference between the claimed amount of the tax credit and an amount of the tax credit that is allowed.

8. The computerized system of claim 7, wherein the pre-qualifying step includes examining a quantitative component that examines expenditures by the taxpayer that are directly related to criteria for the credit set forth by the taxing authority for the credit.

9. The computerized system of claim 8, wherein the quantitative component includes items selected from a list consisting of: employee time and wages; costs of supplies;
and contractor costs.

10. The computerized system of claim 7, wherein the pre-qualifying step includes examining a qualitative component that examines documentation provided by the taxpayer for its evidentiary value.

11. The computerized system of claim 10, wherein the documentation is selected from a list consisting of: purchase orders, invoices, documentation related to software development and W-2s.

12. The computerized system of claim 7, wherein the report demonstrates applicability of the taxpayer's situation to criteria set forth by the taxing authority and includes an executive summary that shows the results of the computation along with a summary of the report.
